(19) United States
(12) Patent Application Publication
(10) Pub. No.: US 2008/0190772 A1
(43) Pub. Date: Aug. 14, 2008

(54) APPARATUS AND METHOD FOR REMOVING PARTICLES FROM AIR

(75) Inventors: Henry Greist, Gainesville, FL (US); Sanjeev Hingorani, Gainesville, FL (US)

Correspondence Address: LAW OFFICE OF DONALD D. MONDUL, 3060 Bonsai Drive, Plano, TX, 75093, US

(73) Assignee: Lennox Manufacturing, Inc., a Corporation of Delaware, Richardson, TX (US)

(21) Appl. No.: 11/673,340

(22) Filed: Feb. 9, 2007

(51) Int. Cl. B01D 35/06

(52) U.S. Cl. 204/572; 204/665

(57) ABSTRACT

An electrically enhanced filter apparatus for removing particles from air passing through the filter in a flow path from an upstream locus to a downstream locus includes: a plurality of electrically conductive particle-permeable electrodes situated in the flow path. A first electrode is an electrically conductive permeable electrode situated substantially at the upstream locus. A second electrode is an electrically conductive permeable electrode situated downstream of the first electrode in spaced relation with the first electrode. The second electrode is coupled with a voltage source sufficient to effect ionizing of the particles passing though the second electrode. A third electrode is situated downstream of the second electrode in spaced relation with the second electrode. A fourth electrode is situated downstream of the third electrode in spaced relation with the third electrode. A particle-permeable filter element is situated between the third electrode and the fourth electrode.

### BACKGROUND OF THE INVENTION

The present invention is directed to apparatuses and methods for filtering air, and especially to apparatuses and methods for filtering air using a plurality of electrically conductive filter elements.

Manufacturers of equipment employing air filtration continually seek structures and methods for air filtration that are less expensive to make an use while maintaining a desirable level of particle removal from filtered air. Multiple filter elements arranged within a flow of filtered air are known to aid in removing particles. Other techniques include ionizing particles and establishing a potential across a permeable filter entrapping element.

Efficiency of air filtering apparatuses and processes may be measured in terms of energy used for effecting a particular level of particle removal. Energy used may be measured by pressure drop across a filtering apparatus; more energy is required to drive a fan at a higher speed to effect a greater pressure drop.

Another factor affecting cost of manufacture of a filtering apparatus is the number of elements contained in the filtering apparatus. Increasing the number of filter elements in a filtering apparatus increases the cost of manufacturing the filtering apparatus.

There is a need for an apparatus and method for removing particles from air that is efficient in operation and inexpensive to manufacture.

### SUMMARY OF THE INVENTION

An electrically enhanced filter apparatus for removing particles from air passing through the filter in a flow path from an upstream locus to a downstream locus includes: a plurality of electrically conductive particle-permeable electrodes situated in the flow path. A first electrode is an electrically conductive permeable electrode situated substantially at the upstream locus. A second electrode is an electrically conductive permeable electrode situated downstream of the first electrode in spaced relation with the first electrode. The second electrode is coupled with a voltage source sufficient to effect ionizing of the particles passing though the second electrode. A third electrode is situated downstream of the second electrode in spaced relation with the second electrode. A fourth electrode is situated downstream of the third electrode in spaced relation with the third electrode. A particle-permeable filter element is situated between the third electrode and the fourth electrode.

A method for removing particles from air passing through a filter in a flow path from an upstream locus to a downstream locus includes: (a) providing a plurality of electrically conductive particle-permeable electrodes situated in the flow path; (b) situating a first electrically conductive permeable electrode of the plurality of electrodes substantially at the upstream locus; (c) situating a second electrically conductive permeable electrode of the plurality of electrodes downstream of the first electrode in spaced relation with the first electrode and coupled with a voltage source sufficient to effect ionizing of the particles passing though the second electrode; (d) situating a third electrically conductive permeable electrode downstream of the second electrode in spaced relation with the second electrode; (e) situating a fourth electrically conductive permeable electrode downstream of the third electrode in spaced relation with the third electrode; and (f) situating a particle-permeable filter element between the third electrode and the fourth electrode.

It is, therefore, a feature of the present invention to provide an apparatus and method for removing particles from air that is efficient in operation and inexpensive to manufacture.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram of a first embodiment of the filter apparatus of the present invention.

FIG. 2 is a schematic diagram of a second embodiment of the filter apparatus of the present invention.

FIG. 3 is a schematic diagram of a third embodiment of the filter apparatus of the present invention.

FIG. 4 is a flow chart illustrating the method of the present invention.

### DETAILED DESCRIPTION OF THE PREFERRED EMBODIMENT

The apparatus of the present invention is embodied in its preferred embodiment in a four-electrode filtration apparatus. Preferably the electrodes are electrically conductive permeable electrodes that are arrayed, from upstream to downstream in the flow of air being filtered, in a first expanded metal electrode, a wire ionizing array, a second expanded metal electrode, a permeable filter element and a third expanded metal electrode. Preferably, the first expanded metal electrode is grounded and the wire ionizing array is a high voltage electrode. By way of example and not by way of limitation, voltage on the wire ionizing array may be 15 kiloVolts, 17.5 kiloVolts or 20 kiloVolts.

Preferably the first electrode pair—the first expanded metal electrode and the wire ionizing array—cooperate to ionize and charge particles in the treated air flowing through the filter apparatus. Filter elements adjacent to the filter element—the second and third expanded metal electrodes—cooperate to aid in polarizing the filter medium to enable a stronger attraction between particles in the air and the filter medium.

In some embodiments of the present invention, electrodes adjacent to the filter medium may establish an electric field across the filter medium. In some embodiments of the present invention, selected electrodes may be permitted to electrically float. Floating electrodes are not coupled with an electric potential, or with an electrical ground, but are allowed to assume an induced voltage or charge. Floating electrodes have an induced charge polarity that is opposite of the polarity of the closest high voltage or grounded electrode. A floating electrode can impart a charge to particles or can aid in filter polarization without the cost of requiring that an apparatus generate additional voltage or current to establish a charge for effecting polarization.

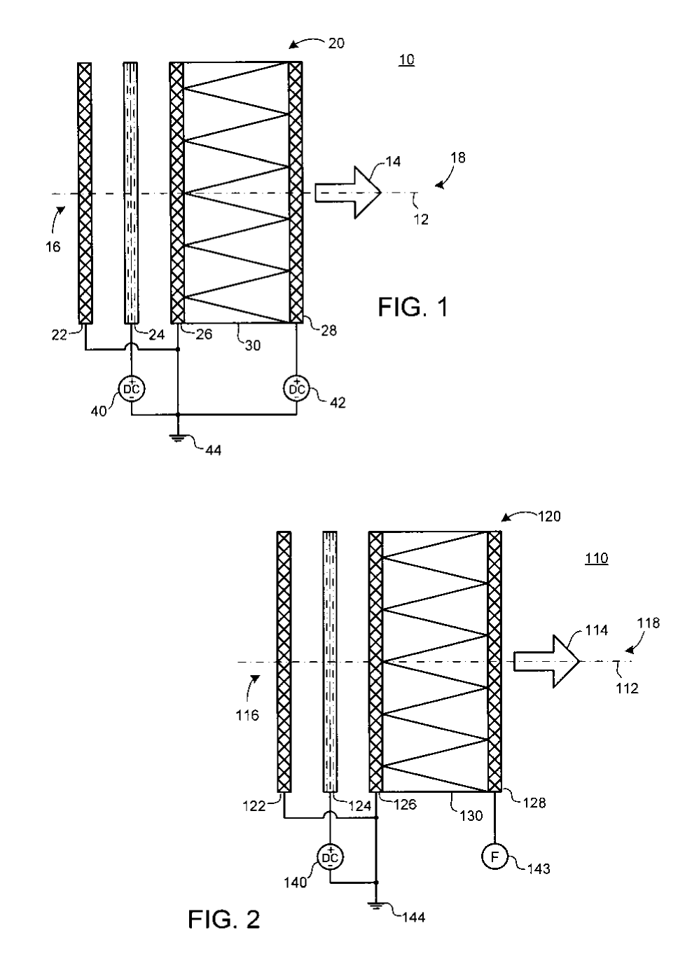

FIG. 1 is a schematic diagram of a first embodiment of the filter apparatus of the present invention. In FIG. 1, a filter apparatus 10 is configured for filtering air passing through filter apparatus 10 along a flow path generally centered on an axis 12 in a flow direction indicated by an arrow 14 from an upstream locus 16 to a downstream locus 18. Filter apparatus 10 includes an array 20 of a plurality of filter elements. Array 20 includes a first filter element 22 situated substantially at upstream locus 16. First filter element 22 is preferably an electrically conductive permeable electrode configured to pass particles in air traversing filter apparatus 10 generally unimpeded absent any electrical influence by first filter element 22. In its most preferred embodiment first filter element 22 is configured as an expanded metal electrode.

Array 20 also includes a second filter element 24 situated downstream of first filter element 22 in spaced relation with first filter element 22. Second filter element 24 is preferably an electrically conductive permeable electrode configured to pass particles in air traversing filter apparatus 10 generally unimpeded absent any electrical influence by second filter element 24. In its preferred embodiment second filter element 24 is configured as a wire ionizing array coupled with a voltage source 40. Preferably voltage source 40 imparts sufficient voltage to second filter element 24 to substantially ionize particles in air traversing second filter element 24.

Array 20 also includes a third filter element 26 situated downstream of second filter element 24 in spaced relation with second filter element 24. Third filter element 26 is preferably an electrically conductive permeable electrode configured to pass particles in air traversing filter apparatus 10 generally unimpeded absent any electrical influence by third filter element 26. In its most preferred embodiment third filter element 26 is configured as an expanded metal electrode.

Array 20 also includes a fourth filter element 28 situated downstream of third filter element 26 in spaced relation with third filter element 26. Fourth filter element 28 is preferably an electrically conductive permeable electrode configured to pass particles in air traversing filter apparatus 10 generally unimpeded absent any electrical influence by fourth filter element 28. In its most preferred embodiment fourth filter element 28 is configured as an expanded metal electrode.

Array 20 also includes a fifth filter element 30 situated between filter elements 26, 28. Fifth filter element 30 is preferably a permeable filter element configured of a filtering material. By way of example and not by way of limitation, fifth filter element 30 may be configured using paper material, fiberglass material or another material known to those skilled in air filter design for effecting a filtering action regarding particles in air traversing the filter material.

In the embodiment of the apparatus of the present invention illustrated in FIG. 1, as mentioned earlier herein, second filter element 24 is coupled with a voltage source 40. Voltage source 40 preferably imparts sufficient voltage to second filter element 24 to substantially ionize particles in air traversing second filter element 24. Fourth filter element 28 is coupled with a voltage source 42. Voltage source 42 preferably imparts sufficient voltage to fourth filter element 28 to permit fourth filter element 28 to cooperate with third filter element 26 for establishing an electric filed across fifth filter element 30 sufficient to aid filtering action by fifth filter element 30 for removing particles from air traversing fifth filter element 30. Filter elements 22, 26 are coupled with a ground 44 to permit filter elements 22, 26 to cooperate with filter elements 24, 28 in establishing desired electric fields within filter apparatus 10.

FIG. 2 is a schematic diagram of a second embodiment of the filter apparatus of the present invention. In FIG. 2, a filter apparatus 110 is configured for filtering air passing through filter apparatus 110 along a flow path generally centered on an axis 112 in a flow direction indicated by an arrow 114 from an upstream locus 116 to a downstream locus 118. Filter apparatus 110 includes an array 120 of a plurality of filter elements. Array 120 includes a first filter element 122 situated substantially at upstream locus 116. First filter element 122 is preferably an electrically conductive permeable electrode configured to pass particles in air traversing filter apparatus 110 generally unimpeded absent any electrical influence by first filter element 122. In its most preferred embodiment first filter element 122 is configured as an expanded metal electrode.

Array 120 also includes a second filter element 124 situated downstream of first filter element 122 in spaced relation with first filter element 122. Second filter element 124 is preferably an electrically conductive permeable electrode configured to pass particles in air traversing filter apparatus 110 generally unimpeded absent any electrical influence by second filter element 124. In its preferred embodiment second filter element 124 is configured as a wire ionizing array coupled with a voltage source 140. Preferably voltage source 140 imparts sufficient voltage to second filter element 124 to substantially ionize particles in air traversing second filter element 124.

Array 120 also includes a third filter element 126 situated downstream of second filter element 124 in spaced relation with second filter element 124. Third filter element 126 is preferably an electrically conductive permeable electrode configured to pass particles in air traversing filter apparatus 110 generally unimpeded absent any electrical influence by third filter element 126. In its most preferred embodiment third filter element 126 is configured as an expanded metal electrode.

Array 120 also includes a fourth filter element 128 situated downstream of third filter element 126 in spaced relation with third filter element 126. Fourth filter element 128 is preferably an electrically conductive permeable electrode configured to pass particles in air traversing filter apparatus 110 generally unimpeded absent any electrical influence by fourth filter element 128. In its most preferred embodiment fourth filter element 128 is configured as an expanded metal electrode.

Array 120 also includes a fifth filter element 130 situated between filter elements 126, 128. Fifth filter element 130 is preferably a permeable filter element configured of a filtering material. By way of example and not by way of limitation, fifth filter element 130 may be configured using paper material, fiberglass material or another material known to those skilled in air filter design for effecting a filtering action regarding particles in air traversing the filter material.

In the embodiment of the apparatus of the present invention illustrated in FIG. 2, as mentioned earlier herein, second filter element 124 is coupled with a voltage source 140. Voltage source 140 preferably imparts sufficient voltage to second filter element 124 to substantially ionize particles in air traversing second filter element 124. Fourth filter element 128 is not coupled with a voltage source or with a ground potential but is rather permitted to electrically float, as indicated by an unconnected node 143.

Filter elements 122, 126 are coupled with a ground 144 to permit filter elements 122, 126 to cooperate with filter elements 124, 128 in establishing desired electric fields within filter apparatus 110.

A floating electrode such as fourth filter element 128 may assume an induced voltage or charge having an induced charge polarity that is opposite of the polarity of the closest high voltage or grounded electrode. In the case of filter apparatus 110 (FIG. 2) fourth filter element 128 may have an induced positive charge polarity that is opposite of the grounded or zero charge on nearest electrode or filter element 126. Floating electrode fourth filter element 128 can impart a charge to particles or can aid in polarization of an electric filed across fifth filter element 130 without the cost of requiring that filter apparatus 110 generate additional voltage or current to establish a charge for charging fourth filter element 128 so as to effect polarization across fifth filter element 130. Establishing an electric field across fifth filter element 130 may aid filtering action by fifth filter element 130 for removing particles from air traversing fifth filter element 130.

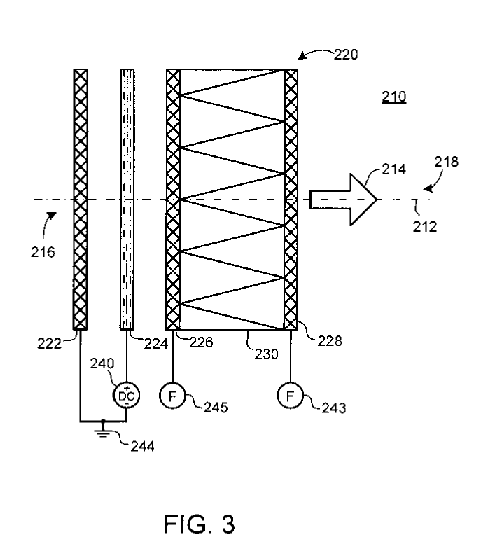

FIG. 3 is a schematic diagram of a third embodiment of the filter apparatus of the present invention. In FIG. 3, a filter apparatus 210 is configured for filtering air passing through filter apparatus 210 along a flow path generally centered on an axis 212 in a flow direction indicated by an arrow 214 from an upstream locus 216 to a downstream locus 218. Filter apparatus 210 includes an array 220 of a plurality of filter elements. Array 220 includes a first filter element 222 situated substantially at upstream locus 216. First filter element 222 is preferably an electrically conductive permeable electrode configured to pass particles in air traversing filter apparatus 210 generally unimpeded absent any electrical influence by first filter element 222. In its most preferred embodiment first filter element 222 is configured as an expanded metal electrode.

Array 220 also includes a second filter element 224 situated downstream of first filter element 222 in spaced relation with first filter element 222. Second filter element 224 is preferably an electrically conductive permeable electrode configured to pass particles in air traversing filter apparatus 210 generally unimpeded absent any electrical influence by second filter element 224. In its preferred embodiment second filter element 224 is configured as a wire ionizing array coupled with a voltage source 240. Preferably voltage source 240 imparts sufficient voltage to second filter element 224 to substantially ionize particles in air traversing second filter element 224.

Array 220 also includes a third filter element 226 situated downstream of second filter element 224 in spaced relation with second filter element 224. Third filter element 226 is preferably an electrically conductive permeable electrode configured to pass particles in air traversing filter apparatus 210 generally unimpeded absent any electrical influence by third filter element 226. In its most preferred embodiment third filter element 226 is configured as an expanded metal electrode.

Array 220 also includes a fourth filter element 228 situated downstream of third filter element 226 in spaced relation with third filter element 226. Fourth filter element 228 is preferably an electrically conductive permeable electrode configured to pass particles in air traversing filter apparatus 210 generally unimpeded absent any electrical influence by fourth filter element 228. In its most preferred embodiment fourth filter element 228 is configured as an expanded metal electrode.

Array 220 also includes a fifth filter element 230 situated between filter elements 226, 228. Fifth filter element 230 is preferably a permeable filter element configured of a filtering material. By way of example and not by way of limitation, fifth filter element 230 may be configured using paper material, fiberglass material or another material known to those skilled in air filter design for effecting a filtering action regarding particles in air traversing the filter material.

In the embodiment of the apparatus of the present invention illustrated in FIG. 3, as mentioned earlier herein, second filter element 224 is coupled with a voltage source 240. Voltage source 240 preferably imparts sufficient voltage to second filter element 224 to substantially ionize particles in air traversing second filter element 224. Third filter element 226 is not coupled with a voltage source or with a ground potential but is rather permitted to electrically float, as indicated by an unconnected node 245. Also, fourth filter element 228 is not coupled with a voltage source or with a ground potential but is rather permitted to electrically float, as indicated by an unconnected node 243.

Filter element 222 is coupled with a ground 244 to permit filter element 222 to cooperate with filter element 224 in establishing desired electric fields within filter apparatus 210.

Floating electrodes such as third filter element 226 and fourth filter element 228 may assume an induced voltage or charge having an induced charge polarity that is opposite of the polarity of the closest high voltage or grounded electrode. In the case of filter apparatus 210 (FIG. 3) third filter element 226 may have an induced negative charge polarity that is opposite of the positively charged second filter element 224. Fourth filter element 228 may have an induced positive charge polarity that is opposite of the induced negative charge on third filter element 226. Floating electrodes 226, 228 can aid in polarization of an electric filed across fifth filter element 130 without the cost of requiring that filter apparatus 210 generate additional voltage or current to establish a charge for charging one or both of filter elements 226, 228 so as to effect polarization across fifth filter element 230. Establishing an electric field across fifth filter element 230 may aid filtering action by fifth filter element 230 for removing particles from air traversing fifth filter element 230.

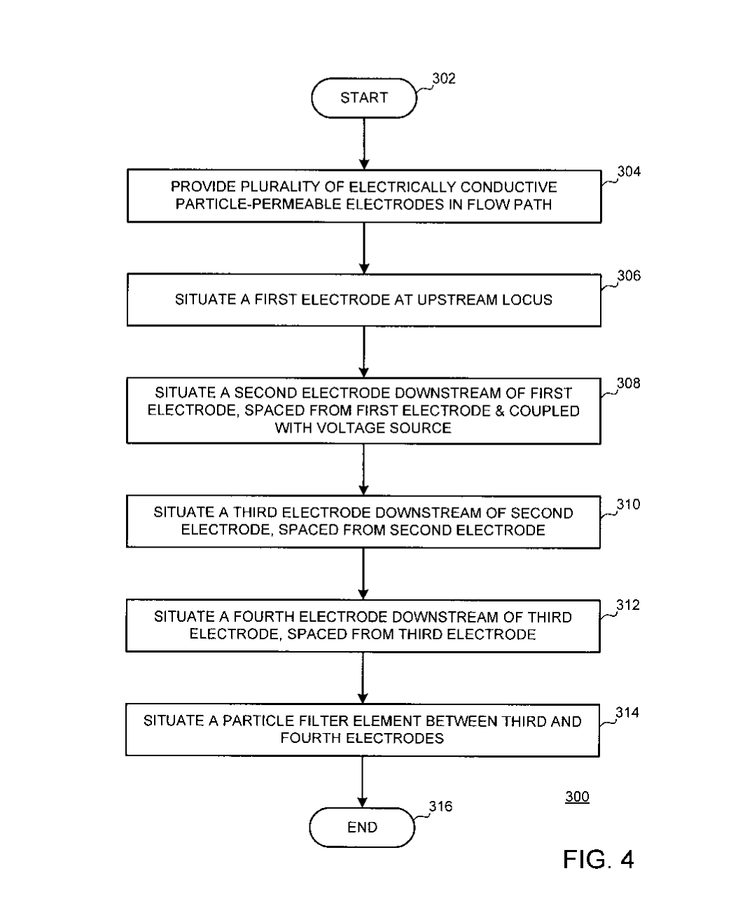

FIG. 4 is a flow chart illustrating the method of the present invention. In FIG. 4, a method 300 for removing particles from air passing through a filter in a flow path from an upstream locus to a downstream locus begins at a START locus 302. Method 300 continues with providing a plurality of electrically conductive particle-permeable electrodes situated in the flow path, as indicated by a block 304.

Method 300 continues with situating a first electrically conductive permeable electrode of the plurality of electrodes substantially at the upstream locus, as indicated by a block 306.

Method 300 continues with situating a second electrically conductive permeable electrode of the plurality of electrodes downstream of the first electrode in spaced relation with the first electrode and coupled with a voltage source sufficient to effect ionizing of the particles passing though the second electrode, as indicated by a block 308.

Method 300 continues with situating a third electrically conductive permeable electrode downstream of the second electrode in spaced relation with the second electrode, as indicated by a block 310.

Method 300 continues with situating a fourth electrically conductive permeable electrode downstream of the third electrode in spaced relation with the third electrode, as indicated by a block 312.

Method 300 continues with situating a particle-permeable filter element between the third electrode and the fourth electrode, as indicated by a block 314. Method 300 ends at an END locus 316.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An electrically enhanced filter apparatus for removing particles from air passing through the filter in a flow direction from an upstream locus to a downstream locus; the apparatus comprising:
(a) an first electrode situated substantially at said upstream locus; said first electrode being an electrically conductive permeable electrode;
(b) a second electrode situated downstream of said first electrode in spaced relation with said first electrode; said second electrode being an electrically conductive permeable electrode;
(c) a third electrode situated downstream of said second electrode in spaced relation with said second electrode; said third electrode being an electrically conductive permeable electrode;
(d) a fourth electrode situated downstream of said third electrode in spaced relation with said third electrode; said fourth electrode being an electrically conductive permeable electrode; and
(e) a permeable filter element situated between said third electrode and said fourth electrode.

2. An electrically enhanced filter apparatus as recited in claim 1 wherein said second electrode is coupled with a voltage source; said voltage source being sufficient to effect ionizing of said particles passing through said second electrode.

3. An electrically enhanced filter apparatus as recited in claim 1 wherein said second electrode and said fourth electrode are coupled with a voltage source; said voltage source being sufficient to effect ionizing of said particles passing through said second electrode.

4. An electrically enhanced filter apparatus as recited in claim 3 wherein said first electrode and said third electrode are coupled with a ground.

5. An electrically enhanced filter apparatus as recited in claim 2 wherein said third electrode and said fourth electrode are configured to electrically float.

6. An electrically enhanced filter apparatus as recited in claim 5 wherein said first electrode is coupled with a ground.

7. An electrically enhanced filter apparatus as recited in claim 2 wherein fourth electrode is configured to electrically float; and wherein said first electrode and said third electrode are coupled with a ground.

8. An electrically enhanced filter apparatus for removing particles from air passing through the filter in a flow path from an upstream locus to a downstream locus; the apparatus comprising: a plurality of electrically conductive particle-permeable electrodes situated in said flow path; a first electrode of said plurality of electrodes being situated substantially at said upstream locus; said first electrode being an electrically conductive permeable electrode; a second electrode of said plurality of electrodes being situated downstream of said first electrode in spaced relation with said first electrode; said second electrode being coupled with a voltage source sufficient to effect ionizing of said particles passing though said second electrode; being an electrically conductive permeable electrode; a third electrode situated downstream of said second electrode in spaced relation with said second electrode; a fourth electrode situated downstream of said third electrode in spaced relation with said third electrode; and a particle-permeable filter element situated between said third electrode and said fourth electrode.

9. An electrically enhanced filter apparatus as recited in claim 8 wherein said second electrode and said fourth electrode are coupled with a voltage source; said voltage source being sufficient to effect ionizing of said particles passing through said second electrode.

10. An electrically enhanced filter apparatus as recited in claim 9 wherein said first electrode and said third electrode are coupled with a ground.

11. An electrically enhanced filter apparatus as recited in claim 8 wherein said third electrode and said fourth electrode are configured to electrically float.

12. An electrically enhanced filter apparatus as recited in claim 11 wherein said first electrode is coupled with a ground.

13. An electrically enhanced filter apparatus as recited in claim 8 wherein fourth electrode is configured to electrically float; and wherein said first electrode and said third electrode are coupled with a ground.

14. A method for removing particles from air passing through a filter in a flow path from an upstream locus to a downstream locus; the method comprising:
(a) providing a plurality of electrically conductive particle-permeable electrodes situated in said flow path;
(b) situating a first electrically conductive permeable electrode of said plurality of electrodes substantially at said upstream locus;
(c) situating a second electrically conductive permeable electrode of said plurality of electrodes downstream of said first electrode in spaced relation with said first electrode and coupled with a voltage source sufficient to effect ionizing of said particles passing though said second electrode;
(d) situating a third electrically conductive permeable electrode downstream of said second electrode in spaced relation with said second electrode;
(e) situating a fourth electrically conductive permeable electrode downstream of said third electrode in spaced relation with said third electrode; and
(f) situating a particle-permeable filter element between said third electrode and said fourth electrode.

15. A method for removing particles from air passing through a filter as recited in claim 14 wherein said second electrode and said fourth electrode are coupled with a voltage source; said voltage source being sufficient to effect ionizing of said particles passing through said second electrode.

16. A method for removing particles from air passing through a filter as recited in claim 15 wherein said first electrode and said third electrode are coupled with a ground.

17. A method for removing particles from air passing through a filter as recited in claim 14 wherein said third electrode and said fourth electrode are configured to electrically float.

18. A method for removing particles from air passing through a filter as recited in claim 17 wherein said first electrode is coupled with a ground.

19. A method for removing particles from air passing through a filter as recited in claim 14 wherein fourth electrode is configured to electrically float; and wherein said first electrode and said third electrode are coupled with a ground.
